(19) United States
(12) Patent Application Publication
(10) Pub. No.: US 2010/0266941 A1
(43) Pub. Date: Oct. 21, 2010

(54) CONDUCTIVE ROLLER

(76) Inventor: Akira MINAGOSHI, Kobe-shi (JP)

Correspondence Address: BIRCH STEWART KOLASCH & BIRCH, PO BOX 747, FALLS CHURCH, VA, 22040-0747, US

(21) Appl. No.: 12/709,898

(22) Filed: Feb. 22, 2010

(30) Foreign Application Priority Data
Apr. 21, 2009 (JP) 2009-103278

(51) Int. Cl. G03G 5/04

(52) U.S. Cl. 430/66

(57) ABSTRACT

A conductive roller including a plurality of protrusion and a plurality of recessed grooves is manufactured by cylindrically extrusion-molding a thermoplastic elastomer composition that includes an elastomer composition a salt of an anion having a fluoro group and a sulfonyl group and lithium; an ethylene oxide-propylene oxide-allyl glycidyl ether copolymer; at least one material selected from the group consisting of an ethylene-acrylic ester-maleic anhydride copolymer and an ethylene-acrylic ester-glycidyl methacrylate copolymer; and not less than 1.5 parts by mass and not more than 16 parts by mass of acrylic-modified polytetrafluoroethylene with respect to 100 parts by mass of the rubber content. The difference in elevation between the highest points of the protrusions and the lowest points of the recessed grooves is not less than 100 μm, and the pitch between the highest points of the protrusions adjacent to one another in the peripheral direction is not more than 800 μm.

### BACKGROUND OF THE INVENTION

1. Field of the Invention

The present invention relates to a conductive roller employable as a transfer roller or the like for transferring a toner image formed on the surface of a photosensitive body or an image carrier to the surface of a sheet in an electrophotographic apparatus such as a laser printer, for example.

2. Description of Related Art

In an electrophotographic apparatus such as a laser printer, an electrostatic copier, a plain paper facsimile or a composite apparatus thereof, the surface of a photosensitive body is exposed in a uniformly charged state for forming an electrostatic latent image corresponding to an image to be formed on the surface (charging step→exposing step), the electrostatic latent image is developed into a toner image by selectively bonding a previously charged toner thereto (developing step), thereafter the toner image is transferred to the surface of a sheet (including a plastic film or the like: this also applies to the following description) (transferring step), and the toner image is further fixed (fixing step), whereby an image is formed on the surface of the sheet.

For example, a full-color electrophotographic apparatus forms a full-color image by successively overlappingly transferring cyan, magenta, yellow and black toner images formed in color separation on the surfaces of photosensitive bodies for the respective colors to the surface of the sheet in the transferring step. Alternatively, the apparatus forms the full-color toner image by temporarily overlappingly transferring the toner images of the respective colors to the surface of an image carrier and thereafter transferring the toner images to the surface of the sheet.

A conductive or semiconductive roller (may hereinafter be generically referred to as “conductive roller”) is widely employed in the charging step included in the aforementioned steps, processes for charging the toner and bonding the same to the electrostatic latent image in the developing step, the transferring step, and a cleaning step of removing the toner remaining on the surface of the photosensitive body or the image carrier after the toner image is transferred to the surface of the sheet.

When the sheet is passed through the space between the photosensitive body or the image carrier and the conductive roller serving as a transfer roller with application of a prescribed voltage therebetween, for example, the toner image formed on the surface of the photosensitive body or the image carrier can be transferred to the surface of the sheet due to electrostatic force between the photosensitive body or the image carrier and the transfer roller.

The conductive roller is generally formed by a porous body of crosslinked (vulcanized) rubber, and a filler such as conductive carbon having electronic conductivity is blended into the rubber or rubber having inn conductivity itself is employed in order to supply conductivity to the roller.

However, a conductive roller made of crosslinked rubber is limited in recyclability. At the best, the conductive roller is pulverized to be recycled as a filler or a bulking agent for resin or rubber, for example. In recent years, therefore, studies have been made for preparing a conductive roller from a thermoplastic elastomer composition moldable into an arbitrary shape by heating and remelting and not limited in recyclability dissimilarly to the crosslinked rubber.

For example, each of Patent Document 1 (Japanese Unexamined Patent Publication No. 2004-51829), Patent Document 2 (Japanese Unexamined Patent Publication No. 2004-269854) and Patent Document 3 (Japanese Unexamined Patent Publication No. 2008-45031) discloses a conductive roller made of a thermoplastic elastomer composition obtained by adding an ion-conductive agent to an elastomer composition prepared by dynamically crosslinking rubber in thermoplastic resin and/or a thermoplastic elastomer thereby supplying ion conductivity. More specifically, the conductive roller is manufactured by cutting a cylindrical body obtained by extrusion-molding the thermoplastic elastomer composition into a prescribed length, inserting a shaft made of a metal into the cylindrical body and polishing the outer peripheral surface thereof.

When the conductive roller is repeatedly and continuously used for image formation as a roller, such as a transfer roller of an electrophotographic apparatus, for example, of a portion directly coming into contact with sheets, a bulking agent, a filler etc. contained in the sheets tend to separate from the sheets as the so-called sheet dust, adhere to the outer peripheral surface of the conductive roller and gradually accumulate on the outer peripheral surface.

In the case of a conventional transfer roller formed by a porous body of crosslinked rubber, most of the sheet dust is incorporated into the porous body through an opening exposed on the outer peripheral surface thereof. Therefore, the slightly accumulating sheet dust hardly exerts an influence on formed images.

However, the conductive roller prepared by extrusion-molding the thermoplastic elastomer composition is a nonporous body, whose outer peripheral surface is smooth dissimilarly to that of the transfer roller formed by the porous body. If sheet dust slightly accumulates on the outer peripheral surface of the conductive roller, therefore, the accumulating sheet dust easily re-adheres to the surface of the photosensitive body or the image carrier from the outer peripheral surface. Further, the sheet dust is amorphous and remarkably greater in particle size than the toner, and generally has chargeability different from that of the toner. If the sheet dust re-adheres to the surface of the photosensitive body or the image carrier, therefore, defectives such as blanking or black spotting are easily caused on the formed images by the sheet dust.

Patent Document 4 (Japanese Unexamined Patent Publication No. 8-74835 (1996)) discloses a conductive roller manufactured by providing a conductive layer made of thermoplastic resin on the outer periphery of a conductive shaft through a conductive base layer. The conductive layer is cylindrically extrusion-molded with an extrusion molding machine including a die having a plurality of recess portions and a plurality of projecting portions alternately provided on the inner peripheral surface of a mouthpiece in the peripheral direction so that a plurality of protrusions and a plurality of recessed grooves corresponding to the recess portions and the projecting portions respectively are alternately provided on the outer peripheral surface of the conductive layer in the peripheral direction.

The conductive roller manufactured according to Patent Document 4 is employed as a charging roller charging the surface of a photosensitive body mainly in a charging step. The outer peripheral surface of the conductive roller is irregularized for preventing occurrence of charging sounds or deterioration of fusibility of a toner when uniformly charging the surface of the photosensitive body by contact charging. However, sheet dust can be incorporated into the recessed grooves, and hence formation of defective images resulting from re-adhesion of accumulating sheet dust can conceivably be suppressed when the conductive roller is employed as a transfer roller or the like.

Therefore, the irregularities may conceivably be applied to the aforementioned conductive roller made of the thermoplastic elastomer composition. However, the thermoplastic elastomer composition causes larger friction with the mouthpiece of the die in the extrusion molding as compared with the thermoplastic resin described in Patent Document 4 (thermoplastic resin, also including a thermoplastic elastomer as a simple substance, does not include the thermoplastic elastomer composition). Therefore, such a problem easily arises that particularly the portions of the protrusions are not smoothly extruded from the mouthpiece but separated from the outer peripheral surface of the conductive roller, and a roller having prescribed excellent irregularities on the outer peripheral surface cannot be formed.

A countermeasure of reducing the extrusion speed or improving the fluidity of the thermoplastic elastomer composition by increasing the extrusion temperature may conceivably be taken in order to solve the problem. In the former case, however, the extrusion speed must be remarkably reduced in order to prevent the protrusions from separation or the like, and the productivity of the conductive roller is extremely reduced in this case.

In the latter case, the extrusion temperature must be remarkably increased in order to prevent the protrusions from separation or the like, and the components constituting the thermoplastic elastomer composition are deteriorated to extremely reduce the flexibility, the wear resistance, the durability etc. of the conductive roller in this case.

In the invention described in Patent Document 4, therefore, the conductive roller has the multilayer structure of the base layer and the conductive layer as hereinabove described, and the base layer is made of expandable or unexpandable conductive rubber or conductive polyurethane foam to ensure excellent flexibility while the conductive layer is made of the thermoplastic resin not so flexible as the base layer but easily extrusion-moldable for easily forming prescribed excellent irregularities by the extrusion molding.

When the conductive roller has such a multilayer structure, however, the number of the manufacturing steps is increased to reduce the productivity of the conductive roller, and it is difficult to adjust the properties and the thicknesses of the base layer and the conductive layer.

### SUMMARY OF THE INVENTION

An object of the present invention is to provide a conductive roller wholly made of a single thermoplastic elastomer composition and provided on the outer peripheral surface thereof with prescribed excellent irregularities causing no separation or the like of protrusions by extrusion molding without reducing the extrusion speed for the thermoplastic elastomer composition or increasing the extrusion temperature therefor.

The present invention provides a conductive roller manufactured by cylindrically extrusion-molding a thermoplastic elastomer composition with an extrusion molding machine including a die having a plurality of recess portions and a plurality of projecting portions alternately provided on the inner peripheral surface of a mouthpiece in the peripheral direction to have a plurality of protrusions and a plurality of recessed grooves corresponding to the recess portions and the projecting portions alternately provided on the outer peripheral surface in the peripheral direction, wherein

the thermoplastic elastomer composition contains:

(1) an elastomer composition prepared by dispersing a crosslinked substance of at least one rubber content selected from the group consisting of diene rubber and ethylene-propylene rubber and paraffinic oil into mixed resin of a styrene-based thermoplastic elastomer and polypropylene;

(2) a salt of an anion having a fluoro group and a sulfonyl group and lithium;

(3) an ethylene oxide-propylene oxide-allyl glycidyl ether copolymer;

(4) at least one material selected from the group consisting of an ethylene-acrylic ester-maleic anhydride copolymer and an ethylene-acrylic ester-glycidyl methacrylate copolymer; and

(5) not less than 1.5 parts by mass and not more than 16 parts by mass of acrylic-modified polytetrafluoroethylene with respect to 100 parts by mass of the rubber content, and

the difference in elevation between the highest points of the protrusions and the lowest points of the recessed grooves is not less than 100 μm, and the pitch between the highest points of the protrusions adjacent to one another in the peripheral direction is not more than 800 μm.

According to the present invention, the acrylic-modified polytetrafluoroethylene blended into the thermoplastic elastomer composition forming the conductive roller in the prescribed ratio functions to increase melting tension of the thermoplastic elastomer composition and reduce friction between the same and a mouthpiece of a die in the extrusion molding.

Therefore, a conductive roller wholly made of a single thermoplastic elastomer composition and provided on the outer peripheral surface thereof with prescribed excellent irregularities causing no separation or the like of protrusions can be manufactured by extrusion molding without reducing the extrusion speed or increasing the extrusion temperature.

In relation to ordinary extrusion molding, ordinary unmodified polytetrafluoroethylene is well known as a component functioning to reduce friction between molten resin and a mouthpiece of a die.

However, such unmodified polytetrafluoroethylene cannot attain effects equivalent to those of the acrylic-modified polytetrafluoroethylene when a conductive roller provided on the outer peripheral surface thereof with fine irregularities in the aforementioned range is manufactured by extrusion-molding a thermoplastic elastomer composition mainly composed of an elastomer composition prepared by dynamically crosslinking rubber in thermoplastic resin and/or a thermoplastic elastomer.

Acrylic-modified polytetrafluoroethylene exhibits the aforementioned specific effects conceivably because the acrylic-modified polytetrafluoroethylene is fibrillated due to shearing force at the time of preparing the thermoplastic elastomer composition by blending the components (1) to (5) and kneading the same while heating the same to constitute a fine fibrous network in the thermoplastic elastomer composition thereby superiorly improving the melting tension as compared with unmodified polytetrafluoroethylene and more reliably preventing the protrusions from separation or the like in the extrusion molding due to a synergetic effect with the function, specific to the polytetrafluoroethylene, of reducing friction between molten resin and a mouthpiece of a die.

In the present invention, the compounding ratio of the acrylic-modified polytetrafluoroethylene is limited to not less than 1.5 parts by mass and not more than 16 parts by mass with respect to 100 parts by mass of the rubber content for the following reasons:

If the compounding ratio of the acrylic-modified polytetrafluoroethylene is below the aforementioned range, the effects described above cannot be attained by blending the acrylic-modified polytetrafluoroethylene, and prescribed excellent irregularities causing no separation or the like of the protrusions cannot be formed on the outer peripheral surface by extrusion molding.

If the compounding ratio of the acrylic-modified polytetrafluoroethylene exceeds the aforementioned range, on the other hand, not only no further effects can be attained, but the flexibility of the conductive roller is reduced, the hardness thereof is increased and a coefficient of friction with respect to a sheet is reduced such that defective sheet feeding or the like may be caused when the conductive roller is used as a transfer roller, for example.

In the present invention, the difference in elevation between the highest points of the protrusions and the lowest points of the recessed grooves in the irregularities formed on the outer peripheral surface of the conductive roller is limited to not less than 100 μm for the following reason:

If the difference in elevation is below the aforementioned range, the quantity and the size of sheet dust receivable in the recessed grooves are limited, and hence the aforementioned effects of suppressing re-adhesion of the sheet dust and subsequent formation of defective images cannot be attained by providing the irregularities.

The pitch between the highest points of the protrusions adjacent to one another in the peripheral direction is limited to not more than 800 μm for the following reasons:

When the conductive roller according to the present invention is used as a transfer roller, for example, a difference in strength based on the irregularities is caused in electrostatic force generated by applying a voltage between the transfer roller and a photosensitive body or an image carrier. In other words, the electrostatic force is strong on the portions of the protrusions in contact with the photosensitive body or the image carrier through a sheet, while the same is weak on the portions of the recessed grooves separated from the photosensitive body or the image carrier.

When the pitch is not more than 800 μm, the difference in strength of the electrostatic force can be reduced by compensating for the electrostatic force in the recessed grooves by superposition of the strong electrostatic force between the protrusions adjacent to one another, thereby hardly exerting an influence on a formed image.

If the pitch exceeds the aforementioned range, however, the difference in strength of the electrostatic force based on the irregularities is so increased that a toner image transferred from the photosensitive body or the image carrier to the surface of the sheet may have visually recognizable unevenness of density.

The protrusions and the recessed grooves, which may be spirally formed on the outer peripheral surface of the conductive roller, are preferably parallelly provided in the axial direction.

If the protrusions and the recessed grooves are spirally provided, unevenness of density based on the difference in strength of the electrostatic force may be conspicuous depending on the type of the formed image, even if the pitch between the highest points of the protrusions adjacent to one another in the peripheral direction is in the aforementioned range. When the protrusions and the recessed grooves are parallelly provided in the axial direction, on the other hand, the unevenness of density can be rendered more inconspicuous.

The elastomer composition (1) for the thermoplastic elastomer composition is preferably prepared by dynamic crosslinking for crosslinking rubber by kneading a mixture containing the rubber content not yet crosslinked, the paraffinic oil and the mixed resin while heating the same.

Thus, the crosslinked substance of rubber can be more finely and homogenously dispersed into the mixed resin, whereby a thermoplastic elastomer composition as well as a conductive roller having uniform characteristics can be obtained.

The thermoplastic elastomer composition preferably contains, with respect to 100 parts by mass of the rubber content:

not less than 50 parts by mass and not more than 250 parts by mass of the paraffinic oil;

not less than 10 parts by mass and not more than 150 parts by mass of the mixed resin;

not less than 0.01 parts by mass and not more than 10 parts by mass of the salt of the anion having the fluoro group and the sulfonyl group and the lithium;

not less than 1 part by mass and not more than 20 parts by mass of the ethylene oxide-propylene oxide-allyl glycidyl ether copolymer;

not less than 1 part by mass and not more than 20 parts by mass of at least one material selected from the group consisting of the ethylene-acrylic ester-maleic anhydride copolymer and the ethylene-acrylic ester-glycidyl methacrylate copolymer; and

not less than 1.5 parts by mass and not more than 16 parts by mass of the acrylic-modified polytetrafluoroethylene.

According to the present invention, a conductive roller wholly made of a single thermoplastic elastomer composition and provided on the outer peripheral surface thereof with prescribed excellent irregularities causing no separation or the like of protrusions by extrusion molding can be provided without reducing the extrusion speed for the thermoplastic elastomer composition or increasing the extrusion temperature therefor.

The foregoing and other objects, features and effects of the present invention will become more apparent from the following detailed description of the embodiments with reference to the attached drawings.

### BRIEF DESCRIPTION OF THE DRAWINGS

FIG. 1 is a perspective view showing the whole of a conductive roller according to an embodiment of the present invention while showing a part thereof in an enlarged manner.

FIG. 2 is a side elevational view showing the part of the conductive roller shown in FIG. 1 in a more enlarged manner.

FIG. 3 is a partially enlarged perspective view for illustrating a step of manufacturing the conductive roller shown in FIG. 1 by extrusion molding.

### DESCRIPTION OF EMBODIMENTS

### Thermoplastic Elastomer Composition

A thermoplastic elastomer composition for a conductive roller according to the present invention contains:

(1) an elastomer composition prepared by dispersing a crosslinked substance of at least one rubber content selected from the group consisting of diene rubber and ethylene-propylene rubber and paraffinic oil into mixed resin of a styrene-based thermoplastic elastomer and polypropylene;

(2) a salt of an anion having a fluoro group and a sulfonyl group and lithium;

(3) an ethylene oxide-propylene oxide-allyl glycidyl ether copolymer;

(4) at least one material selected from the group consisting of an ethylene-acrylic ester-maleic anhydride copolymer and an ethylene-acrylic ester-glycidyl methacrylate copolymer; and

(5) not less than 1.5 parts by mass and not more than 16 parts by mass of acrylic-modified polytetrafluoroethylene with respect to 100 parts by mass of the rubber content.

The elastomer composition (1) can be prepared by dynamic crosslinking for crosslinking rubber by kneading a mixture containing at least one uncrosslinked rubber content selected from the group consisting of the diene rubber and the ethylene-propylene rubber, the paraffinic oil and the mixed resin while heating the same.

The diene rubber can be prepared from natural rubber (NR) isoprene rubber (IR) butadiene rubber (BR) styrene-butadiene copolymer rubber (SBR), chloroprene rubber (CR) or acrylonitrile-butadiene copolymer rubber (NBR), for example. The ethylene-propylene rubber can be prepared from ethylene-propylene copolymer rubber (EPM) or ethylene-propylene-diene copolymer rubber (EPDM), for example. Any one of the rubber materials may be singly used or not less than two thereof may be used as the rubber content.

In particular, EPDM is preferable. The EPDM has a main chain made of saturated hydrocarbon and contains no double bond, and hence the main chain is hardly cut even if the EPDM is exposed to an environment such as a high-concentration ozone atmosphere or photoirradiation including ultraviolet irradiation. Therefore, the EPDM can improve ozone resistance, ultraviolet resistance, heat resistance etc. of the conductive roller. While the EPDM is preferably singly employed, the EPDM and another rubber content may be employed together, and the ratio of the EPDM occupying the whole of the rubber content is preferably not less than 50 percent by mass, particularly preferably not less than 80 percent by mass in this case.

The paraffinic oil serves as a softener rendering the mixture easily kneadable when dynamically crosslinking the rubber content for more finely and uniformly dispersing the crosslinked substance of the rubber content into the mixed resin, and functions to improve the flexibility of the conductive roller made of the thermoplastic elastomer composition containing the elastomer composition for hardly causing the aforementioned defective sheet feeding or the like.

The paraffinic oil can be prepared from any paraffinic oil purified from mineral oil (crude oil) with paraffinic base oil.

The compounding ratio of the paraffinic oil is preferably not less than 50 parts by mass and not more than 250 parts by mass, particularly preferably not less than 80 parts by mass and not more than 120 parts by mass with respect to 100 parts by mass of the rubber content.

If the compounding ratio of the paraffinic oil is below the aforementioned range, the aforementioned effect may not be sufficiently attained by blending the paraffinic oil. If the compounding ratio of the paraffinic oil exceeds the aforementioned range, on the other hand, not only no further effect is attained, but excess paraffinic oil may bleed on the surface of the conductive roller to contaminate the surface of the photosensitive body or the image carrier or stain the sheet.

In the mixed resin, the styrene-based thermoplastic elastomer functions to supply excellent flexibility to the conductive roller while maintaining the thermoplasticity of the thermoplastic elastomer composition. The styrene-based thermoplastic elastomer can be prepared from one or more of a styrene-butadiene-styrene copolymer (SBS), a styrene-isoprene-styrene copolymer (SIS), a styrene-ethylene/propylene copolymer (SEP), a styrene-ethylene/propylene-styrene copolymer (SEPS), a styrene-ethylene/butylene-styrene copolymer (SEBS) and a styrene-ethylene-ethylene/propylene-styrene copolymer (SEEPS), for example.

Among these materials, SEP, SEPS, SEBS and SEEPS, particularly SEEPS is preferable. Each of such styrene-based thermoplastic elastomers having a main chain made of saturated hydrocarbon and containing no double bond is flexible, has small compression set, and is excellent in durability. Further, the styrene-based thermoplastic elastomer is not crosslinked by reacting with a crosslinking agent in the dynamic crosslinking, whereby the thermoplastic elastomer composition can be supplied with excellent thermoplasticity. In addition, the styrene-based thermoplastic elastomer does not inhibit crosslinking of the rubber content in the dynamic crosslinking, whereby the conductive roller can be supplied with excellent rubber elasticity.

The polypropylene constituting the mixed resin along with the styrene-based thermoplastic elastomer functions to improve workability of the thermoplastic elastomer composition in the extrusion molding. The polypropylene can be prepared from one or more polypropylene materials such as homopolymer-type polypropylene prepared by polymerizing only propylene and random or block copolymer-type polypropylene prepared by copolymerizing a small quantity of another olefin such as ethylene in order to improve low-temperature brittleness etc. of the homopolymer-type polypropylene.

The compounding ratio of the mixed resin containing at least the polypropylene and the styrene-based thermoplastic elastomer is preferably not less than 10 parts by mass and not more than 150 parts by mass, particularly preferably not less than 50 parts by mass and not more than 100 parts by mass with respect to 100 parts by mass of the rubber content.

If the compounding ratio of the mixed resin is below the aforementioned range, the quantity of the mixed resin serving as a thermoplastic component is so excessively small that the thermoplastic elastomer composition may not be supplied with excellent thermoplasticity. Further, the rubber content crosslinked by the dynamic crosslinking may not be excellently dispersible into the mixed resin. If the compounding ratio of the mixed resin exceeds the aforementioned range, on the other hand, the quantity of the rubber content is so relatively reduced that the conductive roller may not be supplied with excellent rubber elasticity.

The compounding ratio of the polypropylene with respect to 100 parts by mass of the styrene-based thermoplastic elastomer is preferably not less than 1 part by mass and not more than 100 parts by mass, particularly preferably not less than 30 parts by mass and not more than 50 parts by mass.

If the compounding ratio of the polypropylene is below the aforementioned range, the aforementioned effect of improving the workability of the thermoplastic elastomer composition in the extrusion molding may not be sufficiently attained by blending the polypropylene. If the compounding ratio of the polypropylene exceeds the aforementioned range, on the other hand, the quantity of the styrene-based thermoplastic elastomer is so relatively reduced that the flexibility of the conductive roller may be reduced to cause defective sheet feeding or the like.

When the rubber content is dynamically crosslinked, a crosslinking agent for crosslinking the rubber content is added to the mixture of the aforementioned components. The crosslinking agent is preferably prepared from a resin crosslinking agent.

The resin crosslinking agent is synthetic resin capable of causing crosslinking reaction on the rubber content by heating or the like, causes no bloom dissimilarly to an ordinary sulfur crosslinking agent (a system employing both of sulfur and a vulcanization accelerator or the like), and can minimize compression set and reduction of physical properties in the crosslinked rubber content and improve durability thereof.

According to the resin crosslinking agent, the crosslinking time can be reduced as compared with the sulfur crosslinking agent. When the elastomer composition (1) is continuously prepared by heating, kneading, dynamically crosslinking and extruding the rubber content not yet crosslinked, the paraffinic oil, the mixed resin and the resin crosslinking agent in a biaxial extruder, therefore, the dynamic crosslinking can be progressed within a short time when the materials remain in the biaxial extruder.

The resin crosslinking agent can be prepared from phenolic resin, melamine-formaldehyde resin, a triazine-formaldehyde condensate or hexamethoxymethyl melamine resin, for example, and phenolic resin is particularly preferable.

The phenolic resin can be synthesized by reaction between phenol such as phenol, alkylphenol, cresol, xylenol or resorcin and aldehyde such as formaldehyde, acetaldehyde or furfural, for example. Alternatively, the phenolic resin can be prepared from halogenated phenolic resin prepared by bonding at least one halogen atom to an aldehyde unit of phenolic resin.

The phenolic resin is particularly preferably prepared from alkylphenol-formaldehyde resin obtained by reaction between alkylphenol having an alkyl group bonded to the ortho position or the para position of benzene and formaldehyde, which is excellent in compatibility with the rubber content, rich in reactivity and capable of relatively quickening the starting time of the crosslinking reaction.

The alkyl group of the alkylphenol-formaldehyde resin can be prepared from an alkyl group having a carbon number of 1 to 10, such as a methyl group, an ethyl group, a propyl group or a butyl group, for example. A halide of alkylphenol-formaldehyde resin is also preferably employable.

Further, modified alkylphenol resin prepared by addition-condensing p-tert-butylphenol sulfide and aldehyde or alkylphenol-sulfide resin can also be used as the resin crosslinking agent.

The compounding ratio of the resin crosslinking agent is preferably not less than 2 parts by mass and not more than 20 parts by mass, particularly preferably not less than 5 parts by mass and not more than 15 parts by mass with respect to 100 parts by mass of the rubber content.

If the compounding ratio of the resin crosslinking agent is below the aforementioned range, the crosslinking is so insufficient that the conductive roller may not be supplied with excellent rubber elasticity. If the compounding ratio of the resin crosslinking agent exceeds the aforementioned range, on the other hand, the rubber content is so excessively hardened that the flexibility of the conductive roller may be reduced to result in defective sheet feeding or the like.

In order to properly perform the dynamic crosslinking, a crosslinking activator may be added to the mixture. The crosslinking activator can be prepared from a metal oxide such as zinc oxide or zinc carbonate, for example. In particular, zinc oxide (zinc white) is preferable.

The compounding ratio of the crosslinking activator is preferably not less than 0.5 parts by mass and not more than 10 parts by mass, particularly preferably not less than about 1 part by mass and not more than about 5 parts by mass with respect to 100 parts by mass of the rubber content.

The conditions for the dynamic crosslinking are not particularly restricted. However, when the aforementioned biaxial extruder is employed for the dynamic crosslinking, for example, the average temperature of a mixing portion provided on a generally intermediate portion or the like between a hopper and an outlet of the biaxial extruder is preferably not less than 160° C. and not more than 250° C., and the crosslinking time is preferably not less than about one minute and not more than about 20 minutes.

The salt (2) (may hereinafter be also referred to as “lithium salt”) of the anion having the fluoro group and the sulfonyl group and lithium functions as an ion-conductive agent supplying ion conductivity to the thermoplastic elastomer composition. In other words, the anion is stabilized due to the fluoro group and the sulfonyl group both having electron withdrawing property, whereby a lithium ion exhibits a higher degree of dissociation. Therefore, excellent ion conductivity can be supplied to the thermoplastic elastomer composition by adding a small quantity of the lithium salt.

The anion having the fluoro group and the sulfonyl group constituting the lithium salt can be prepared from a fluoroalkyl sulfonic ion, a bis(fluoroalkyl sulfonyl) imide ion or a tris (fluoroalkyl sulfonyl) methide ion, for example.

The lithium salt (2) containing the anion can be prepared from one or more of CF₃SO₃L₁, C₄F₉SO₃Li, (CF₃SO₂)₂NLi, (C₂F₅SO₂)₂NLi (C₄F₉SO₂)(CF₃SO₂)NLi, (FSO₂C₆F₄)(CF₃SO₂)NLi, (C₈F₁₇SO₂)(CF₃SO₂)NLi (CF₃CH₂OSO₂)₂NLi (CF₃CF₂CH₂OSO₂)₂NLi, (HCF₂CF₂CH₂OSO₂)₂NLi, [(CF₃)₂CHOSO₂]₂NLi (CF₃SO₂)₃CLi and (CF₃CH₂OSO₂)₃CLi, for example.

In particular, CF₃SO₃Li (lithium trifluoromethanesulfonate) or (CF₃SO₂)₂NLi [bis(trifluoromethanesulfonyl)imidolithium] is preferable.

The compounding ratio of the lithium salt is preferably not less than 0.01 parts by mass and not more than 10 parts by mass, particularly preferably not less than 0.5 parts by mass and not more than 2 parts by mass with respect to 100 parts by mass of the rubber content.

If the compounding ratio of the lithium salt is below the aforementioned ratio, it may not be possible to supply excellent ion conductivity to the thermoplastic elastomer composition. If the compounding ratio of the lithium salt exceeds the aforementioned ratio, on the other hand, not only no further effect is attained, but excess lithium salt may bleed on the surface of the conductive roller to contaminate the surface of the photosensitive body or the image carrier.

The thermoplastic elastomer composition is preferably prepared by blending the lithium salt with the ethylene oxide-propylene oxide-allyl glycidyl ether copolymer (may hereinafter be abbreviated as “EO-PO-AGE copolymer”) at prescribed ratios for preparing a mixture, thereafter blending the mixture with the elastomer composition (1) and the like, and kneading the obtained substance while heating the same.

Thus, ions derived from the lithium salt are stabilized by ethylene oxide units and propylene oxide units in the EO-PO-AGE copolymer, whereby the lithium salt can excellently function as an ion-conductive agent. In particular, the ethylene oxide units are excellent in the stabilizing function.

The EO-PO-AGE copolymer may be crosslinked.

When a mixture is prepared by blending the crosslinking agent, a crosslinking assistant and the like into the EO-PO-AGE copolymer and the lithium salt not yet blended with the elastomer composition (1) and others, the mixture is blended with the elastomer composition (1) and others and the obtained substance is kneaded under heating for preparing the thermoplastic elastomer composition, the EO-PO-AGE copolymer can be dynamically crosslinked at the same time due to the functions of the crosslinking agent, the crosslinking assistant and the like.

Alternatively, the thermoplastic elastomer composition can be prepared by previously kneading the mixture while heating the same for crosslinking the EO-PO-AGE copolymer, thereafter blending the mixture with the elastomer composition (1) and the like, and kneading the obtained substance while heating the same.

The content of the ethylene oxide units in the EO-PO-AGE copolymer is preferably not less than 65 mole percent and not more than 95 mole percent.

If the content of the ethylene oxide units is below the aforementioned range, the aforementioned effect of stabilizing the ions derived from the lithium salt cannot be sufficiently attained through the ethylene oxide units. If the content of the ethylene oxide units exceeds the aforementioned range, on the other hand, the ethylene oxide units are crystallized, and the effect of stabilizing the ions derived from the lithium salt cannot be sufficiently attained. In either case, therefore, the lithium salt may not sufficiently function as the ion-conductive agent.

The content of allyl glycidyl ether units in the EO-PO-AGE copolymer is preferably not less than 1 mole percent and not more than 10 mole percent.

If the content of the allyl glycidyl ether units is below the aforementioned range, the EO-PO-AGE copolymer may bleed on the surface of the conductive roller along with the lithium salt, and the bleeding lithium salt may contaminate the surface of the photosensitive body or the image carrier. If the content of the allyl glycidyl ether units exceeds the aforementioned range, on the other hand, the tensile strength, the fatigue characteristics, the flex resistance etc. of the EO-PO-AGE copolymer may be reduced to exert an influence on the durability etc. of the conductive roller.

In order to prevent the bleeding and the resulting contamination of the surface of the photosensitive body or the image carrier, the number average molecular weight of the EO-PO-AGE copolymer is preferably not less than 10000, particularly preferably not less than 30000.

The compounding ratio of the EO-PO-AGE copolymer is preferably not less than 1 part by mass and not more than 20 parts by mass, particularly preferably not less than 1 part by mass and not more than 15 parts by mass with respect to 100 parts by mass of the rubber content.

If the compounding ratio of the EO-PO-AGE copolymer is below the aforementioned range, the aforementioned effect of stabilizing the ions derived from the lithium salt may not be sufficiently attained through the EO-PO-AGE copolymer, and the thermoplastic elastomer composition may not be supplied with excellent ion conductivity. If the compounding ratio of the EO-PO-AGE copolymer exceeds the aforementioned range, on the other hand, no further effect may be attained.

The crosslinking agent for crosslinking the EO-PO-AGE copolymer is preferably prepared from a peroxide.

The peroxide can be prepared from one or more of benzoyl peroxide, 1,1-bis(tert-butyl peroxy)-3,3,5-trimethylcyclohexane, 2,5-dimethyl-2,5-di(benzoylperoxy)hexane, di(tert-butyl peroxy)diisopropylbenzene, 1,4-bis[(tert-butyl) peroxyisopropyl]benzene, di(tert-butyl peroxy)benzoate, tert-butyl peroxybenzoate, dicumyl peroxide, tert-butylcumyl peroxide, 2,5-dimethyl-2,5-di(tert-butyl peroxy)hexane, ditert-butyl peroxide and 2,5-dimethyl-2,5-di(tert-butyl peroxy)-3-hexene, for example.

In particular, di(tert-butyl peroxy)diisopropylbenzene is preferable.

The compounding ratio of the peroxide is preferably not less than 0.1 parts by mass and not more than 5 parts by mass with respect to 100 parts by mass of the EO-PO-AGE copolymer.

If the compounding ratio of the peroxide is below the aforementioned range, the crosslinking is so insufficient that the aforementioned effect of the crosslinking cannot be sufficiently attained. If the compounding ratio of the peroxide exceeds the aforementioned range, on the other hand, the physical properties are reduced by molecular scission, or the thermoplastic elastomer composition is hard to work due to defective dispersion or the like.

The crosslinking assistant crosslinks itself, and also crosslinks the EO-PO-AGE copolymer to highly polymerize the whole. The crosslinking density can be improved by performing co-crosslinking with the crosslinking assistant.

The crosslinking assistant can be prepared from one or more of a metal salt of methacrylic acid or acrylic acid, methacrylic acid ester, an aromatic vinyl compound, a heterocyclic vinyl compound, an allyl compound, a multifunctional polymer utilizing a functional group of 1,2-polybutadiene and dioxime, for example. More specifically, the crosslinking assistant can be prepared from triallyl isocyanurate (TAIL), triallyl cyanurate (TAC), trimethylol propane trimethacrylate (TMPT), ethylene glycol dimethacrylate (EDMA), p-quinone dioxime, p,p′-dibenzoylquinone dioxime or N,N′-m-phenylene bismaleimide, and N,N′-m-phenylene bismaleimide is particularly preferable.

The compounding ratio of the crosslinking assistant is preferably not less than 0.1 parts by mass and not more than 20 parts by mass, particularly preferably not less than 0.1 parts by mass and not more than 15 parts by mass with respect to 100 parts by mass of the EO-PO-AGE copolymer.

The ethylene-acrylic ester-maleic anhydride copolymer and/or the ethylene-acrylic ester-glycidyl methacrylate copolymer (4) functions as a compatibilizer for the elastomer composition (1) and the EO-PO-AGE copolymer (3) containing the lithium salt (2) to uniformly and stably disperse the lithium salt into the thermoplastic elastomer composition.

The content of acrylic ester units in the ethylene-acrylic ester-maleic anhydride copolymer and/or the ethylene-acrylic ester-glycidyl methacrylate copolymer is preferably not less than 0.1 percent by mass and not more than 30 percent by mass, more preferably not less than 1 percent by mass and not more than 20 percent by mass, particularly preferably not less than 3 percent by mass and not more than 15 percent by mass. The content of maleic anhydride units is preferably not less than 0.05 percent by mass and not more than 20 percent by mass, more preferably not less than 0.1 percent by mass and not more than 15 percent by mass, particularly preferably not less than 1 percent by mass and not more than 10 percent by mass. The content of glycidyl methacrylate units is preferably not less than 0.05 percent by mass and not more than 20 percent by mass, more preferably not less than 0.1 percent by mass and not more than 15 percent by mass, particularly preferably not less than 1 percent by mass and not more than 10 percent by mass.

Acrylic ester can be prepared from one or more of methyl acrylate, ethyl acrylate, propyl acrylate, butyl acrylate, 2-ethylhexyl acrylate, methyl methacrylate, ethyl methacrylate, propyl methacrylate, butyl methacrylate and 2-ethylhexyl methacrylate, for example.

The compounding ratio of the ethylene-acrylic ester-maleic anhydride copolymer and/or the ethylene-acrylic ester-glycidyl methacrylate copolymer is preferably not less than 1 part by mass and not more than 20 parts by mass, particularly preferably not less than 5 parts by mass and not more than 15 parts by mass with respect to 100 parts by mass of the rubber content.

If the compounding ratio of the ethylene-acrylic ester-maleic anhydride copolymer and/or the ethylene-acrylic ester-glycidyl methacrylate copolymer is below the aforementioned range, the function of the ethylene-acrylic ester-maleic anhydride copolymer and/or the ethylene-acrylic ester-glycidyl methacrylate copolymer as the compatibilizer is so insufficient that the elastomer composition (1) and the EO-PO-AGE copolymer (3) containing the lithium salt (2) may be phase-separated in the extrusion molding, for example, and no conductive roller having uniform ion conductivity and excellent rubber elasticity may be formed.

If the compounding ratio of the ethylene-acrylic ester-maleic anhydride copolymer and/or the ethylene-acrylic ester-glycidyl methacrylate copolymer exceeds the aforementioned range, on the other hand, not only no further effect can be attained by adding the same, but the conductive roller may be reduced in strength or increased in hardness.

The acrylic-modified polytetrafluoroethylene (5) can be prepared from, for example:

(a) a material obtained by mixing an aqueous dispersion of polytetrafluoroethylene particles and an aqueous dispersion of acrylic resin particles containing one or more of acrylic acid, methacrylic acid and ester, a salt etc. thereof with each other, introducing the obtained mixed solution into hot water in which metal salt of calcium chloride or magnesium sulfide is dissolved, solidifying the mixed solution and thereafter powdering the same by drying, pulverization or spray drying;

(b) a material obtained by introducing a mixed solution prepared by polymerizing one or more of the acrylic acid, the methacrylic acid and the ester, the salt etc. constituting acrylic acid in the presence of an aqueous dispersion of polytetrafluoroethylene particles into hot water in which metal salt of calcium chloride or magnesium sulfide is dissolved similarly to the above, solidifying the mixed solution and thereafter powdering the same by drying, pulverization or spray drying; or

(c) a material obtained by introducing a mixed solution prepared by emulsion-polymerizing a monomer having ethylenic unsaturated linkage in a dispersion obtained by mixing an aqueous dispersion of polytetrafluoroethylene particles and an aqueous dispersion of acrylic resin particles containing one or more of acrylic acid, methacrylic acid and ester, salt etc. thereof with each other into hot water in which metal salt of calcium chloride or magnesium sulfide is dissolved similarly to the above, solidifying the mixed solution and thereafter powdering the same by drying, pulverization or spray drying.

The acrylic-modified polytetrafluoroethylene is fibrillated due to shearing force at the time of preparing the thermoplastic elastomer composition by blending the components (1) to (5) and kneading the same while heating the same to constitute a fine fibrous network in the thermoplastic elastomer composition, as hereinabove described.

The acrylic-modified polytetrafluoroethylene functions to improve melting tension of the thermoplastic elastomer composition and reduce friction between the same and a mouthpiece of a die in the extrusion molding, whereby a conductive roller wholly made of a single thermoplastic elastomer composition and provided on the outer peripheral surface thereof with prescribed excellent irregularities causing no separation or the like of protrusions can be manufactured by extrusion molding without reducing the extrusion speed or increasing the extrusion temperature.

The compounding ratio of the acrylic-modified polytetrafluoroethylene must be not less than 1.5 parts by mass and not more than 16 parts by mass, and is particularly preferably not less than 5 parts by mass and not more than 10 parts by mass with respect to 100 parts by mass of the rubber content.

If the compounding ratio of the acrylic-modified polytetrafluoroethylene is below the aforementioned range, the aforementioned effect cannot be attained by blending the acrylic-modified polytetrafluoroethylene, and prescribed excellent irregularities causing no separation or the like of protrusions cannot be formed on the outer peripheral surface by extrusion molding.

If the compounding ratio of the acrylic-modified polytetrafluoroethylene exceeds the aforementioned range, on the other hand, not only no further effect is attained, but the conductive roller may be reduced in flexibility to cause defective sheet feeding or the like.

A filler may further be blended into the thermoplastic elastomer composition containing the aforementioned components, in order to improve the mechanical strength of the conductive roller.

The filler can be prepared from one or more of silica, carbon black, clay, talc, calcium carbonate, dibasic lead phosphite (DLP), basic magnesium carbonate and alumina, for example.

The compounding ratio of the filler is preferably not more than 15 percent by mass of the total mass of the thermoplastic elastomer composition.

This is because, while the filler is effective for improving the tensile strength, the tear strength etc. of the thermoplastic elastomer composition, the flexibility of the thermoplastic elastomer composition tends to lower if the filler is excessively blended thereinto.

A blowing agent may be blended into the thermoplastic elastomer composition, in order to improve the flexibility of the conductive roller.

The blowing agent can be prepared from a microencapsulated blowing agent. When the microencapsulated blowing agent is employed, a state of independent bubbles can be formed so that the pore size and the number of the bubbles can be easily controlled, whereby the conductive roller is hardly reduced in wear resistance etc.

The compounding ratio of the blowing agent is preferably not less than 0.1 parts by mass and not more than 10 parts by mass, particularly preferably not less than 0.5 parts by mass and not more than 10 parts by mass with respect to 100 parts by mass of the thermoplastic elastomer composition.

Further, additives such as an age resistor, an antioxidant, an ultraviolet absorber, a lubricant, a pigment, an antistatic agent, a flame retardant, a neutralizer, a nucleator and/or an antifoaming agent may be properly blended into the thermoplastic elastomer composition.

In order to prepare the thermoplastic elastomer composition containing the aforementioned components, the elastomer composition (1) is prepared by kneading the mixture containing the rubber content not yet crosslinked, the paraffinic oil, the mixed resin, the resin crosslinking agent, the crosslinking activator and the like while heating the same thereby dynamically crosslinking the rubber.

The mixture can be kneaded in a biaxial extruder, a Banbury mixer or a kneader, and an extruder such as the biaxial extruder is particularly preferable. When the extruder is employed, the elastomer composition can be prepared by kneading the mixture in a screw portion of the extruder while continuously heating the same and the prepared elastomer composition can be successively extruded from the forward end of a nozzle and continuously fed to a subsequent step (a pelletization step, for example), whereby the productivity of the elastomer composition can be improved.

The dynamic crosslinking is preferably performed in the presence of halogen. The aforementioned halogenated resin crosslinking agent may be employed so that halogen is present in the dynamic crosslinking. Alternatively, a halogen-donative substance such as stannic chloride, ferric chloride or cupric chloride may be added.

Then, the thermoplastic elastomer composition is prepared by feeding a pellet of the prepared elastomer composition (1), the EO-PO-AGE copolymer (3), crosslinked if necessary, containing the lithium salt (2), at least one material selected from the group consisting of the ethylene-acrylic ester-maleic anhydride copolymer and the ethylene-acrylic ester-glycidyl methacrylate copolymer (4) and the acrylic-modified polytetrafluoroethylene (5) to an extrusion molding machine for extrusion-molding a cylindrical body for forming the conductive roller according to the present invention, and kneading the mixture in a screw portion of the extrusion molding machine while heating the same.

If the crosslinking agent or the like crosslinking the EO-PO-AGE copolymer (3) is contained at this time, the EO-PO-AGE copolymer is dynamically crosslinked.

Thereafter the conductive roller according to the present invention is manufactured by cylindrically extrusion-molding the prepared thermoplastic elastomer composition through a mouthpiece of a die connected to the forward end of the screw portion of the extrusion molding machine.

The conditions for the extrusion molding can be set equivalent to those for extrusion-molding a cylindrical body for forming a conventional conductive roller having no irregularities on the outer peripheral surface thereof. In other words, the extrusion temperature (a set temperature on the forward end of the screw portion) can be set to not less than 160° C. and not more than 250° C., more particularly not less than about 180° C. and not more than about 230° C., and the extrusion speed can be set to not less than 0.5 m/min. and not more than 7 m/min., more particularly not less than about 0.8 m/min. and not more than about 5 m/min.

Also when the conditions for the extrusion molding are set in the aforementioned ranges, the thermoplastic elastomer composition can be extrusion-molded into a cylindrical body provided with prescribed excellent irregularities causing no separation or the like of protrusions, due to the aforementioned effect of the acrylic-modified polytetrafluoroethylene (5) blended into the mixture.

The cylindrical body for forming the conductive roller may alternatively be manufactured by kneading the aforementioned components in a biaxial extruder, a Banbury mixer or a kneader while heating the same, thereafter pelletizing the mixture and feeding the formed pellet to an extrusion molding machine. In this case, the temperature and the time for the kneading in advance of the pelletization may be equivalent to those in the aforementioned dynamic crosslinking. Further, the conditions for the extrusion molding may also be equivalent to the above.

(Conductive Roller)

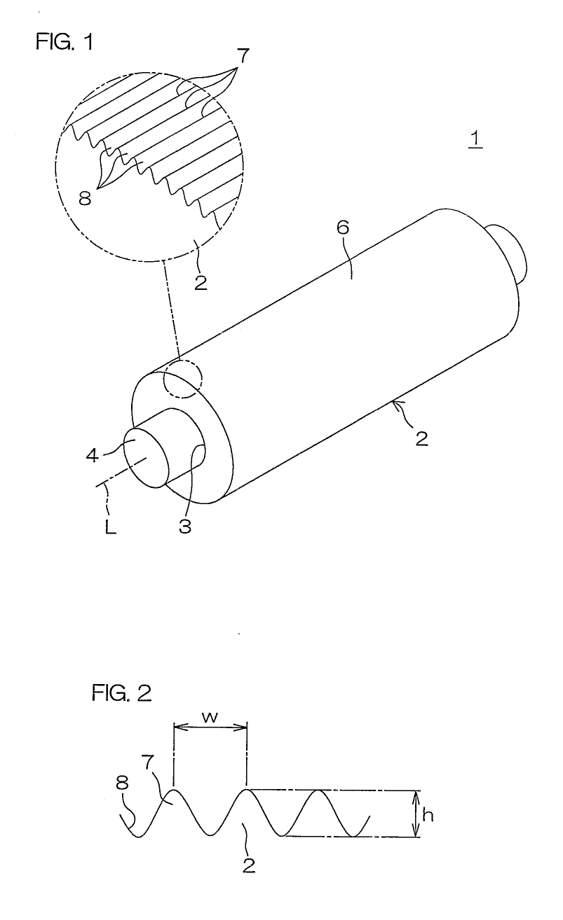

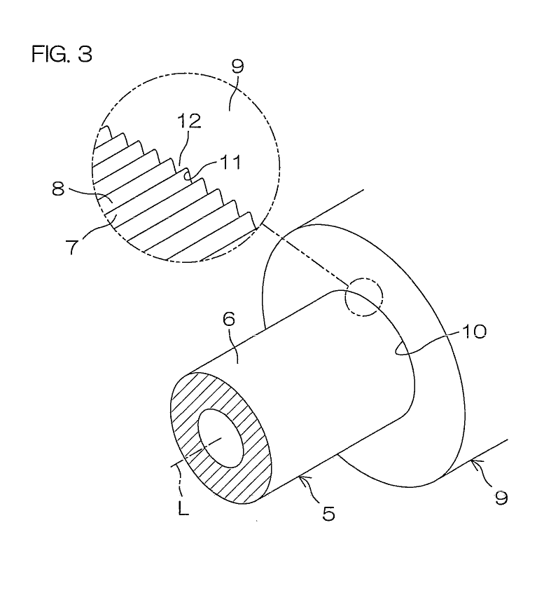

FIG. 1 is a perspective view showing the whole of a conductive roller according to an embodiment of the present invention while showing a part thereof in an enlarged manner. FIG. 2 is a side elevational view showing the part of the conductive roller shown in FIG. 1 in a more enlarged manner. FIG. 3 is a partially enlarged perspective view for illustrating a step of manufacturing the conductive roller shown in FIG. 1 by extrusion molding.

Referring to FIGS. 1 to 3, a conductive roller 1 according to the embodiment includes a cylindrical roller body 2 made of the thermoplastic elastomer composition and a shaft 4 inserted into a through-hole 3 at the center of the roller body 2. The roller body 2 is formed by cutting a cylindrical body 5 (see FIG. 3) formed by extrusion-molding the thermoplastic elastomer composition as hereinabove described into a prescribed length.

A plurality of protrusions 7 and a plurality of recessed grooves 8 are alternately provided on an outer peripheral surface 6 of the roller body 2 in the peripheral direction. The protrusions 7 and the recessed grooves 8 are formed by shaping the outer peripheral surface 6 into generally sinusoidal waves in the case of FIGS. 1 to 3. In other words, crests of the generally sinusoidal waves radially protruding from the roller body 2 define the protrusions 7, while radially dented troughs between the adjacent crests define the recessed grooves 8.

Referring to FIG. 3, the roller body 2 having the irregularities is manufactured by cutting the cylindrical body 5 formed by extrusion-molding the thermoplastic elastomer composition with an extrusion molding machine including a die having a plurality of recess portions 11 and a plurality of projecting portions 12 provided on an inner peripheral surface 10 of a mouthpiece 9 into the prescribed length.

In other words, the protrusions 7 and the recessed grooves 8 are formed on the outer peripheral surface 6 of the cylindrical body 5 extrusion-molded through the mouthpiece 9 correspondingly to the recess portions 11 and the projecting portions 12 respectively. The recess portions 11 and the projecting portions 12 are alternately provided on the inner peripheral surface 10 of the mouthpiece 9 in the peripheral direction, whereby the protrusions 7 and the recessed grooves 8 are also alternately provided on the outer peripheral surface 6 of the extrusion-molded cylindrical body 5 in the peripheral direction, correspondingly to the recess portions 11 and the projecting portions 12 respectively.

When the extrusion-molded cylindrical body 5 is cooled while the same is kept unrotated on a central axis L thereof in the peripheral direction and thereafter cut, the roller body 2 having the protrusions 7 and the recessed grooves 8 parallelly provided in the axial direction of the central axis L is obtained, as shown in FIG. 1. The conductive roller including the roller body 2 can advantageously render unevenness of density based on a difference in strength of electrostatic force resulting from the irregularities more inconspicuous, as hereinabove described.

The protrusions 7 and the recessed grooves 8 may conceivably be provided not parallelly in the axial direction as hereinabove described but spirally on the outer peripheral surface 6 of the roller body 2. In this case, the extrusion-molded cylindrical body 5 may be cooled while the same is peripherally rotated on the central axis L at a constant speed, for example. Thus, the protrusions 7 and the recessed grooves 8 can be spirally formed to be inclined with respect to the central axis L at a prescribed angle of inclination responsive to the speed of the rotation and the speed of the extrusion.

Referring to FIG. 2, the difference h in elevation between the highest points of the protrusions 7 and the lowest points of the recessed grooves 8 in the radial direction must be not less than 100 μm, and the pitch w between the highest points of the protrusions 7 adjacent to one another in the peripheral direction must be not more than 800 μm.

If the difference h in elevation is less then 100 μm, the quantity and the size of sheet dust receivable in the recessed grooves 8 are limited, and hence the aforementioned effects of suppressing re-adhesion of the sheet dust and subsequent formation of defective images cannot be attained by providing the irregularities.

The pitch w is limited to not more than 800 μm for the following reasons:

When the conductive roller 1 according to the present invention is used as a transfer roller, for example, a difference in strength based on the irregularities is caused in electrostatic force generated by applying a voltage between the conductive roller 1 and a photosensitive body or an image carrier. In other words, the electrostatic force is strong on the portions of the protrusions 7 in contact with the photosensitive body or the image carrier through a sheet, and weak on the portions of the recessed grooves 8 separated from the photosensitive body or the image carrier.

When the pitch w is not more than 800 μm, the difference in strength of the electrostatic force can be reduced by compensating for the electrostatic force in the recessed grooves 8 by superposition of the strong electrostatic force between the protrusions 7 adjacent to one another, thereby hardly exerting an influence on a formed image.

If the pitch w exceeds the aforementioned range, however, the difference in strength of the electrostatic force based on the irregularities may be so increased that a toner image transferred from the photosensitive body or the image carrier to the surface of the sheet may have visually recognizable unevenness of density.

The difference h in elevation is preferably not less than 200 μm and not more than 1 mm, particularly preferably not less than 300 μm and not more than 800 μm in the aforementioned range.

If the difference h in elevation exceeds the aforementioned range, the extrusion speed must be reduced or the fluidity of the thermoplastic elastomer composition must be improved by increasing the extrusion temperature in order to form the protrusions 7 having a prescribed difference h in elevation by sufficiently spreading the thermoplastic elastomer composition into the recess portions 11 of the mouthpiece 9, leading to the possibility of causing the aforementioned problems.

If the difference h in elevation exceeds the aforementioned range, further, the protrusions 7 may be easily deformed or chipped, to reduce the durability of the conductive roller 1. If the width of the protrusions 7 is increased in order to improve the durability, the pitch w must be increased beyond the aforementioned range, and unevenness of density may also be caused in this case.

The pitch w is preferably not less than 200 μm, more preferably not less than 300 μm in the aforementioned range.

If the pitch w is below the aforementioned range, the quantity and the size of sheet dust receivable in the recessed grooves 8 may be limited, and hence the aforementioned effects may not be attainable by providing the irregularities. If the pitch w is below the aforementioned range, further, the narrow protrusions 7 having the difference h in elevation in the aforementioned range may be easily deformed or chipped, to reduce the durability of the conductive roller 1.

The shaft 4 is rendered conductive, in order to constitute the conductive roller 1. The conductive shaft 4 can be integrally formed by a metal such as aluminum, an aluminum alloy or stainless steel, for example. Alternatively, the shaft 4 can be made of ceramic or hard resin in a composite structure provided on the outer peripheral surface thereof with a conductive film or the like electrically connected with the roller body 2.

The outer peripheral surface 6 of the roller body 2 may be covered with a coating layer. The coating layer can be formed by applying a coating agent prepared by dispersing powder of fluororesin or the like into an emulsion or a solution of acrylic resin or the like or a rubber latex to the outer surface 6 and drying the same. The outer peripheral surface 6 is so covered with the coating layer that the surface energy thereof can be controlled to suppress adhesion of sheet dust or fixation of a toner to the outer peripheral surface 6 or adjust a coefficient of friction.

The conductive roller according to the present invention can be used as a charging roller of an electrophotographic apparatus for charging the surface of a photosensitive body in a charging step, a charging roller for charging a toner while stirring the same in a toner charging process included in a developing step, a developing roller for selectively bonding the charged toner to an electrostatic latent image on the surface of the photosensitive body and developing the same into a toner image in an electrostatic latent image bonding process, a transfer roller for transferring the toner image to the surface of a sheet or an image carrier in a transferring step, or a cleaning roller for removing the residual toner in a cleaning step.

The conductive roller according to the present invention is particularly preferably used as a transfer roller directly coming into contact with a sheet and hence easily causing various problems resulting from adhesion of sheet dust.

When the conductive roller is used as a transfer roller, the resistance value of the roller body is preferably not less than 10⁴Ω and not more than 10⁹Ω, particularly preferably not less than about 10⁶Ω and not more than about 10⁸Ω with an applied voltage of 1000 V.

In order to adjust the resistance value in the aforementioned range, the types, the compounding ratios etc. of the lithium salt (2) serving as the ion-conductive agent and the EO-PO-AGE copolymer (3) participating in the stabilization of the lithium salt may be properly controlled in the aforementioned ranges.

As to the hardness of the roller body of the conductive roller used as the transfer roller, type C spring hardness measured under conditions of an ambient temperature of 23±1° C. and relative humidity of 55±1% according to the type C testing method of spring hardness defined in the appendix 2 of JIS (Japanese Industrial Standards) K7312₋₁₉₉₆ “Physical testing methods for molded products of thermosetting polyurethane elastomers” is preferably not more than 68, particularly preferably not more than 66.

If the hardness of the roller body is in this range, the coefficient of friction with respect to the sheet can be increased by supplying excellent flexibility to the roller body, to hardly cause defective sheet feeding or the like when the conductive roller is used as the transfer roller.

### EXAMPLES

### Example 1

### Preparation of Elastomer Composition

In Example 1, EPDM [Espren (registered trademark) EPDM505A by Sumitomo Chemical Co., Ltd.] as a rubber content, a hydrogenated styrene-based thermoplastic elastomer [SEEPS, Septon (registered trademark) 4077 by Kuraray Co., Ltd.], polypropylene [Novatec (registered trademark) PP by Japan Polypropylene Corporation], paraffinic oil [Diana (registered trademark) Process Oil PW-380 by Idemitsu Kosan Co., Ltd.], a resin crosslinking agent [alkylphenol bromide-formaldehyde resin, Tacky Roll (registered trademark) 250-III by Taoka Chemical Co., Ltd.] and zinc oxide [zinc white No. 1 by Mitsui Mining and Smelting Co., Ltd.] were blended with one another.

An elastomer composition was prepared by extruding the components from the forward end of a nozzle while heating and kneading the same in a screw portion of a biaxial extruder for dynamically crosslinking the rubber content and then continuously cutting the extruded substance into a prescribed length for pelletizing the same.

(Preparation of Thermoplastic Elastomer Composition and Formation of Roller Body)

Bis(trifluoromethanesulfonyl)imidolithium as lithium salt and an EO-PO-AGE copolymer [Zeospan (registered trademark) 8010 by Nippon Zeon Co., Ltd.] were mixed with each other to prepare a mixture.

Then, the mixture, the elastomer composition prepared in the above, an ethylene-acrylic ester-maleic anhydride copolymer [Bondine (registered trademark) LX4110 by Arkema Inc.] and acrylic-modified polytetrafluoroethylene [Methabrene {registered trademark} A3000 by Mitsubishi Rayon Co., Ltd.] were blended with one another.

The compounding ratios of the components constituting the elastomer composition with respect to 100 parts by mass of the EPDM as the rubber content were set as shown in Table 1.

TABLE 1

| Component | Parts by mass |
|---|---|
| EPDM | 100 |
| Hydrogenated styrene-based | 50 |
| thermoplastic elastomer | |
| Polypropylene | 20 |
| Paraffinic oil | 100 |
| Resin crosslinking agent | 12 |
| Zinc oxide | 5 |
| Lithium salt | 1 |
| EO-PO-AGE copolymer | 10 |
| Ethylene-acrylic ester-maleic | 8 |
| anhydride copolymer | |
| Acrylic-modified | 5 |
| polytetrafluoroethylene | |

A cylindrical body for forming a roller body was manufactured by kneading the components in a screw portion of an extrusion molding machine while heating the same to prepare a thermoplastic elastomer composition and cylindrically extrusion-molding the prepared thermoplastic elastomer composition through a mouthpiece of a die connected to the forward end of the screw portion.

Two conditions, i.e., a low-speed condition of an extrusion speed of about 1 m/min. at an extrusion temperature (a set temperature on the forward end of the screw portion) of 200° C. and a high-speed condition of an extrusion speed of about 3 m/min. at the same extrusion temperature were set for the extrusion molding.

The outer and inner diameters of the cylindrical body were set to 14 mm and 6 mm respectively. As shown in FIG. 3, irregularities in the form of generally sinusoidal waves were provided on the inner peripheral surface 10 of the mouthpiece 9, so that the outer peripheral surface 6 of the extrusion-molded cylindrical body 5 had irregularities in the form of generally sinusoidal waves with the alternately arranged protrusions 7 and recessed grooves 8 corresponding to the recess portions and the projecting portions 12 of the irregularities respectively.

The recess portions 11 and the projecting portions 12 were so set that the difference h in elevation (see FIG. 2) between the highest points of the protrusions 7 and the lowest points of the recessed grooves 8 in the radial direction was 500 μm and the pitch w (see FIG. 2) between the highest points of the protrusions 7 adjacent to one another in the peripheral direction was 500 μm in the extrusion-molded cylindrical body 5.

The cylindrical body 5 was cooled while the same was kept unrotated on the central axis L in the peripheral direction and thereafter cut. Thus, the roller body 2 having the protrusions 7 and the recessed grooves 8 parallelly provided in the axial direction of the central axis L was prepared, as shown in FIG. 1.

### Example 2 and Comparative Examples 1, 2 and 3

In each of Example 2 and comparative examples 1, 2 and 3, a roller body was formed by preparing a thermoplastic elastomer composition similarly to Example 1, except that the compounding ratio of acrylic-modified polytetrafluoroethylene with respect to 100 parts by mass of a rubber content was set to 0 parts by mass (not blended: comparative example 1), 1 part by mass (comparative example 2), 10 parts by mass (Example 2) or 20 parts by mass (comparative example 3).

### Example 3

In Example 3, a roller body was formed by preparing a thermoplastic elastomer composition similarly to Example 1, except that the ethylene-acrylic ester-maleic anhydride copolymer was replaced with the same quantity (8 parts by mass) of an ethylene-acrylic ester-glycidyl methacrylate copolymer as a compatibilizer.

### Comparative Example 4

In comparative example 4, a roller body was formed similarly to Example 1, except that the difference h in elevation between the recess portions 11 and the projecting portions 12 were set to 50 μm.

### Comparative Example 5

In comparative example 5, a roller body was formed similarly to Example 1, except that the pitch w between the highest points of protrusions 7 adjacent to one another was set to 1000 μm.

(Evaluation Test)

The outer peripheral surface of the roller body prepared in each of Examples 1 to 3 and comparative examples 1 to 5 was observed visually or in an enlarged state, for evaluating workability in extrusion molding with the following criteria:

◯: Clear irregularities were formed on the outer peripheral surface under both of the low- and high-speed conditions, and no separation or the like of the protrusions was observed. The workability was excellent.

Δ: The irregularities were nonproblematic under the low-speed condition, while separation or the like of the protrusions was observed under the high-speed condition. The workability was inferior.

X: Separation or the like of the protrusions was observed also under the low-speed condition. The workability was more inferior.

The type C spring hardness of the roller body was measured according to the aforementioned type C testing method of spring hardness.

Further, the roller body manufactured in each of Examples 1 to 3 and comparative examples 1 to 4 was assembled into a laser beam printer [Laser Jet 405 by Hewlett-Packard Japan, Ltd.] as a transfer roller for continuously printing halftone images in an environment having a temperature of 23±1° C. and relative humidity of 55±1%, and the printed images were observed.

The observation was performed on the first to 20^{th} images (initial images) and 1001^{st} to 1020^{th} images (post-endurance images) after continuously printing 1000 images, for evaluating the presence or absence of defectives in the initial and post-endurance images with the following criteria:

◯: Absolutely no defective images were observed, or only about one or two out of the 20 images were defective at a nonproblematic level not conspicuous unless sharply observed. The print quality was excellent.

Δ: Not less than half (10) of the images were apparently defective. The print quality was inferior.

Table 2 shows the results.

TABLE 2

| | | | Comp. | Comp. | | | | Comp. | Comp. | Comp. |
|---|---|---|---|---|---|---|---|---|---|---|
| | | | Ex. 1 | Ex. 2 | EX. 1 | EX. 2 | EX. 3 | Ex. 3 | Ex. 4 | Ex. 5 |
| Conductive | Composition | Acrylic-modified | 0 | 1 | 5 | 10 | 5 | 20 | 5 | 5 |
| Roller | (parts by | polytetrafluoroethylene | | | | | | | | |
| | mass) | Ethylene-acrylic | 8 | 8 | 8 | 8 | — | 8 | 8 | 8 |
| | | ester-maleic | | | | | | | | |
| | | anhydride copolymer | | | | | | | | |
| | | Ethylene-acrylic | — | — | — | — | 8 | — | — | — |
| | | ester-glycidyl | | | | | | | | |
| | | methacrylate copolymer | | | | | | | | |
| | Shape | Difference h in elevation | 500 | 500 | 500 | 500 | 500 | 500 | 50 | 500 |
| | | (μm) | | | | | | | | |
| | | Pitch w (μm) | 500 | 500 | 500 | 500 | 500 | 500 | 500 | 1000 |
| Evaluation | Workability in extrusion molding | | X | Δ | ◯ | ◯ | ◯ | ◯ | ◯ | ◯ |
| | Type C hardness | | 62 | 62 | 64 | 66 | 65 | 71 | 68 | 68 |
| | Print quality | Initial stage | — | — | ◯ | ◯ | ◯ | X | ◯ | X |
| | | Post-endurance stage | — | — | ◯ | ◯ | ◯ | X | X | X |

From the results of Examples 1 to 3 shown in Table 2, it has been recognized that a roller body having clear irregularities causing no separation or the like of protrusions can be formed also under the high-speed condition in particular, by blending acrylic-modified polytetrafluoroethylene into the thermoplastic elastomer composition thereby improving workability in extrusion molding as compared with the case of not blending the acrylic-modified polytetrafluoroethylene (comparative example 1) and the case of blending only a small quantity of the acrylic-modified polytetrafluoroethylene (comparative example 2).

It has also been recognized that the roller body is reduced in flexibility and increased in hardness to easily cause defective sheet feeding or the like if the compounding ratio of the acrylic-modified polytetrafluoroethylene is excessive (comparative example 3).

It has further been recognized that defective images are formed in a post-endurance stage if the difference h in elevation between the highest points of the protrusions and the lowest points of the recessed grooves in the radial direction is less than 100 μm (comparative example 4) and defective images are formed from the initial stage if the pitch w between the highest points of the protrusions adjacent to one another in the peripheral direction exceeds 800 μm (comparative example 5), while formation of defective images resulting from re-adhesion of sheet dust or the like can be reliably prevented over a long period from the initial stage up to the post-endurance stage when the difference h in elevation is not less than 100 and the pitch w is not more than 800 μm.

While the present invention has been described in detail by way of the embodiments thereof, it should be understood that these embodiments are merely illustrative of the technical principles of the present invention but not limitative of the invention. The spirit and scope of the present invention are to be limited only by the appended claims.

This application corresponds to Japanese Patent Application No. 2009-103278 filed with the Japan Patent Office on Apr. 21, 2009, the disclosure of which is incorporated herein by reference.

What is claimed is:

1. A conductive roller, manufactured by cylindrically extrusion-molding a thermoplastic elastomer composition with an extrusion molding machine including a die having a plurality of recess portions and a plurality of projecting portions alternately provided on the inner peripheral surface of a mouthpiece in the peripheral direction to have a plurality of protrusions and a plurality of recessed grooves corresponding to the recess portions and the projecting portions alternately provided on the outer peripheral surface in the peripheral direction, wherein
the thermoplastic elastomer composition contains:
(1) an elastomer composition prepared by dispersing a crosslinked substance of at least one rubber content selected from the group consisting of diene rubber and ethylene-propylene rubber and paraffinic oil into mixed resin of a styrene-based thermoplastic elastomer and polypropylene;
(2) a salt of an anion having a fluoro group and a sulfonyl group and lithium;
(3) an ethylene oxide-propylene oxide-allyl glycidyl ether copolymer;
(4) at least one material selected from the group consisting of an ethylene-acrylic ester-maleic anhydride copolymer and an ethylene-acrylic ester-glycidyl methacrylate copolymer; and
(5) not less than 1.5 parts by mass and not more than 16 parts by mass of acrylic-modified polytetrafluoroethylene with respect to 100 parts by mass of the rubber content, and
the difference in elevation between the highest points of the protrusions and the lowest points of the recessed grooves is not less than 100 μm, and the pitch between the highest points of the protrusions adjacent to one another in the peripheral direction is not more than 800 μm.

2. The conductive roller according to claim 1, wherein
the protrusions and the recessed grooves are parallelly provided in the axial direction.

3. The conductive roller according to claim 1, wherein
the elastomer composition is prepared by dynamic crosslinking for crosslinking rubber by kneading a mixture containing the rubber content not yet crosslinked, the paraffinic oil and the mixed resin while heating the same.

4. The conductive roller according to claim 1, wherein
the thermoplastic elastomer composition contains, with respect to 100 parts by mass of the rubber content:
not less than 50 parts by mass and not more than 250 parts by mass of the paraffinic oil;
not less than 10 parts by mass and not more than 150 parts by mass of the mixed resin;
not less than 0.01 parts by mass and not more than 10 parts by mass of the salt of the anion having the fluoro group and the sulfonyl group and the lithium;
not less than 1 part by mass and not more than 20 parts by mass of the ethylene oxide-propylene oxide-allyl glycidyl ether copolymer;
not less than 1 part by mass and not more than 20 parts by mass of at least one material selected from the group consisting of the ethylene-acrylic ester-maleic anhydride copolymer and the ethylene-acrylic ester-glycidyl methacrylate copolymer; and
not less than 1.5 parts by mass and not more than 16 parts by mass of the acrylic-modified polytetrafluoroethylene.
